(19) United States
(12) Patent Application Publication
(10) Pub. No.: US 2009/0073046 A1
(43) Pub. Date: Mar. 19, 2009

(54) Wide-band Antenna and Related Dual-band Antenna

(76) Inventors: Wei-Shan Chang, Taipei Hsien (TW); Chih-Kai Liu, Taipei Hsien (TW); Chih-Ming Wang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/935,332

(22) Filed: Nov. 5, 2007

(30) Foreign Application Priority Data
Sep. 13, 2007 (TW) 096215398

(51) Int. Cl. H01Q 9/04

(52) U.S. Cl. 343/700 MS

(57) ABSTRACT

The present invention includes a wide-band antenna, which includes a grounding unit electrically connected to a ground, a radiating unit including a first radiator component extending along a first direction, and a second radiator component electrically connected to the first radiator component and extending along an opposite direction of the first direction, a shorting unit electrically connected between the first radiator component and the grounding unit, a feeding unit electrically connected to the first radiator component, and a connector unit electrically connected between the feeding unit and the grounding unit for receiving feeding signals.

### BACKGROUND OF THE INVENTION

1. Field of the Invention

The present invention relates to a wide-band antenna and related dual-band antenna, and more particularly to a wide-band antenna and related dual-band antenna using a first radiator component and a second radiator component for achieving wide-band effect or dual-band effect.

2. Description of the Prior Art

An antenna is used for transmitting or receiving radio waves, so as to exchange radio signals. An electronic product having a communication function, such as a laptop computer, a personal digital assistant and so on, usually accesses wireless network through an embedded antenna. Therefore, to realize convenient wireless network access, an ideal antenna should have a wide bandwidth and a small size to meet a main stream of reducing a size of a portable communication device and integrating an antenna into a laptop computer. In addition, with the advancement of wireless communication technology, different wireless communication systems may have different operating frequencies. For example, Institute of Electrical and Electronics Engineers (IEEE) defines 5 GHz as a central carrier frequency for WLAN (wireless local area network) standard IEEE 802.11a, and 2.4 GHz as a central carrier frequency for WLAN standard IEEE 802.11b. Therefore, an ideal antenna is expected to be a single antenna covering every band used in different wireless communication networks.

In the prior art, a common antenna for wireless communication is an inverted-F antenna. As implied in its name, a shape of an inverted-F antenna is similar to an inverted and rotated “F”. Please refer to FIG. 1 and FIG. 2. FIG. 1 is a lateral-view diagram of an inverted-F antenna 10 according to the prior art, and FIG. 2 is a graph of return loss of the inverted-F antenna 10. The structure and operation of the inverted-F antenna 10 are well known and not given here. As shown in FIG. 2, in a condition of voltage standing wave ratio (VSWR) equal to 2:1, a bandwidth of the inverted-F antenna 10 is equal to 3.28−2.71=0.57(GHz), a central frequency of the inverted-F antenna 10 is equal to (2.71+3.28)/2=2.995(GHz), and a bandwidth percentage of the inverted-F antenna 10 is equal to 0.57/2.995=19.03(%).

From the above, the bandwidth and bandwidth percentage of the inverted-F antenna 10 are not ideal, which limits the application range. For the purpose of improving the inverted-F antenna 10, a TW published application No. 200618387 discloses a wideband metal-plate short-circuit monopole antenna for increasing bandwidth to cover operations of the 2.4 GHz band and the 5 GHz band in the current WLAN systems. In the wideband metal-plate short-circuit monopole antenna disclosed, a short-circuit metal portion is narrow-width, includes a bend and connects to the left side of a radiating unit. In practice, such structure needs more production cost and occupies space, and is easily deformed by an external force, and therefore not suitable for portable wireless communication devices.

### SUMMARY OF THE INVENTION

It is therefore a primary objective of the claimed invention to provide a wide-band antenna and related dual-band antenna.

The present invention discloses a wide-band antenna, which comprises a grounding unit electrically connected to a ground, a radiating unit comprising a first radiator component extending along a first direction, and a second radiator component electrically connected to the first radiator component and extending along an opposite direction of the first direction, a shorting unit electrically connected between the first radiator component and the grounding unit, a feeding unit electrically connected to the first radiator component, and a connector unit electrically connected between the feeding unit and the grounding unit for receiving feeding signals.

The present invention further discloses a dual-band antenna, which comprises a grounding unit electrically connected to a ground, a radiating unit comprising a first radiator component extending along a first direction, and a second radiator component electrically connected to the first radiator component and extending along an opposite direction of the first direction, a shorting unit electrically connected between the first radiator component and the grounding unit, a feeding unit electrically connected to the second radiator component, and a connector unit electrically connected between the feeding unit and the grounding unit for receiving feeding signals.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a lateral-view diagram of an inverted-F antenna according to the prior art.

FIG. 2 is a graph of return loss of the inverted-F antenna shown in FIG. 1.

FIG. 3 is a lateral-view diagram of a wide-band antenna according to an embodiment of the present invention.

FIG. 4 is a schematic diagram of an unfolded plane of the wide-band antenna shown in FIG. 3.

FIG. 5 is a schematic diagram of a current path of a first resonant mode of the wide-band antenna shown in FIG. 3.

FIG. 6 is a schematic diagram of a current path of a second resonant mode of the wide-band antenna shown in FIG. 3.

FIG. 7 is a graph of return loss of the wide-band antenna shown in FIG. 3.

FIG. 8 is a graph of VSWR of the wide-band antenna shown in FIG. 3.

FIG. 9 is a graph of radiation efficiency of the wide-band antenna shown in FIG. 3.

FIG. 10 is a graph of average gain of the wide-band antenna shown in FIG. 3.

FIG. 11 is a graph of radiation pattern of the wide-band antenna shown in FIG. 3.

FIG. 12 is a graph of return loss of the wide-band antenna shown in FIG. 3 after resizing.

FIG. 13 to FIG. 16 are schematic diagrams of a wide-band antenna shown in FIG. 3 with different kinds of modification.

FIG. 17 is a graph of return loss of the wide-band antenna shown in FIG. 16.

FIG. 18 is a lateral-view diagram of a dual-band antenna according to an embodiment of the present invention.

FIG. 19 is a schematic diagram of an unfolded plane of the dual-band antenna shown in FIG. 18.

FIG. 20 is a graph of return loss of the dual-band antenna shown in FIG. 18.

### DETAILED DESCRIPTION

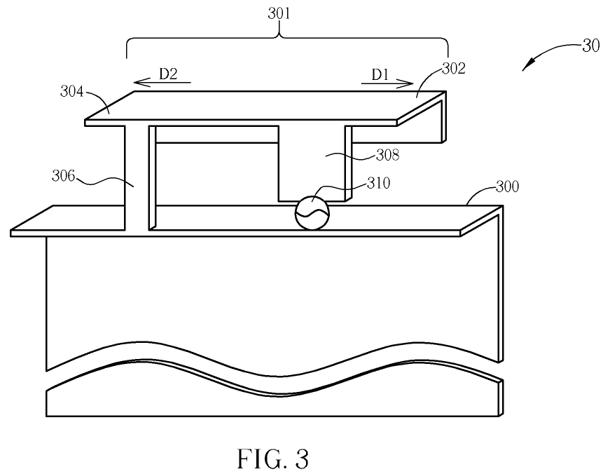

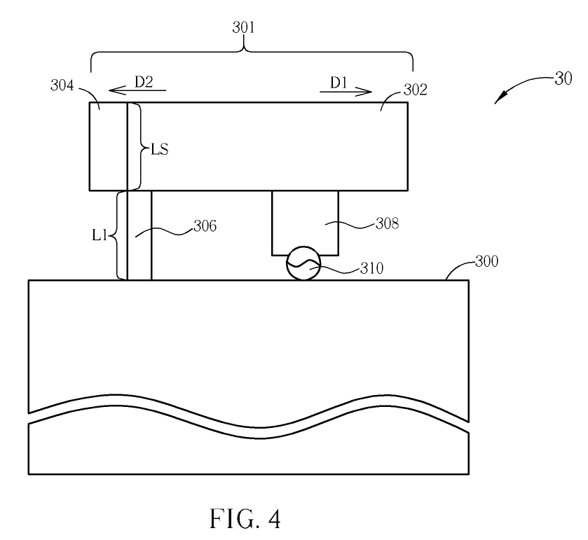

Please refer to FIG. 3 and FIG. 4. FIG. 3 is a lateral-view diagram of a wide-band antenna 30 according to an embodiment of the present invention, and FIG. 4 is a schematic diagram of an unfolded plane of the wide-band antenna 30. The wide-band antenna 30 comprises a grounding unit 300, a radiating unit 301, a shorting unit 306, a feeding unit 308, and a connector unit 310. The radiating unit 301 further comprises a first radiator component 302 and a second radiator component 304. The grounding unit 300 is electrically connected to a ground (not drawn in FIG. 3). The shorting unit 306 is electrically connected between the first radiator component 302 and the grounding unit 300. The feeding unit 308 is electrically connected between the first radiator component 302 and the connector unit 310, and utilized for receiving feeding signals and transmitting radio waves through the first radiator component 302 and the second radiator component 304. The first radiator component 302 and the second radiator component 304, extending along opposite directions D1 and D2, are connected together, and form the radiating unit 301 of the wide-band antenna 30. Preferably, a length of the first radiator component 302 is longer than a length of the second radiator component 304.

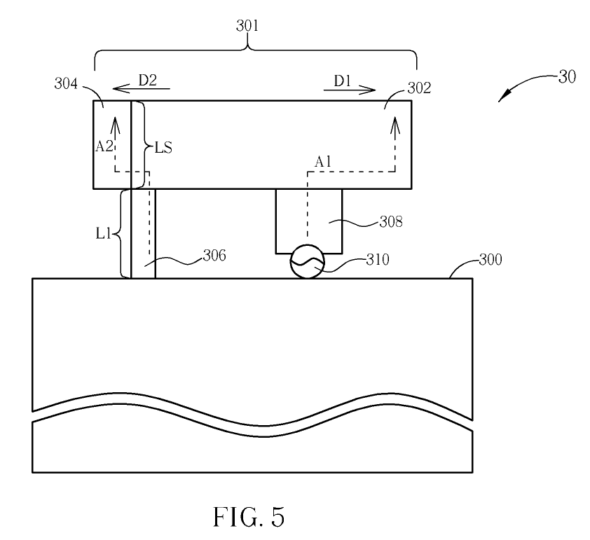

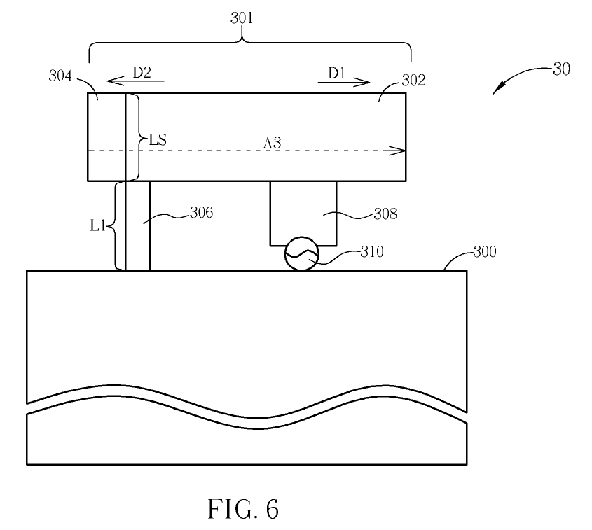

As shown in FIG. 4, a straight line is formed with a boundary LS between the first radiator component 302 and the second radiator component 304 and a side L1 of the shorting unit 306, and that is, the shorting unit 306 is not connected to the second radiator component 304. In such a case, a main function of the second radiator component 304 is to resonate with the first radiator component 302 for generating two resonant modes, so as to increase bandwidth of the wide-band antenna 30. Please refer to FIG. 5 and FIG. 6. FIG. 5 and FIG. 6 are schematic diagrams of current paths of a first resonant mode and a second resonant mode of the wide-band antenna 30. As shown in FIG. 5, in the first resonant mode of the wide-band antenna 30, a current path A1 starts from the grounding unit 300, along the connector unit 310 and the feeding unit 308, to the first radiator component 302. While a current path A2 starts from the grounding unit 300, along the shorting unit 306, to the first radiator component 302 and the second radiator component 304. Moreover, as shown in FIG. 6, in the second resonant mode of the wide-band antenna 30, a current path A3 starts from the second radiator component 304 to the first radiator component 302.

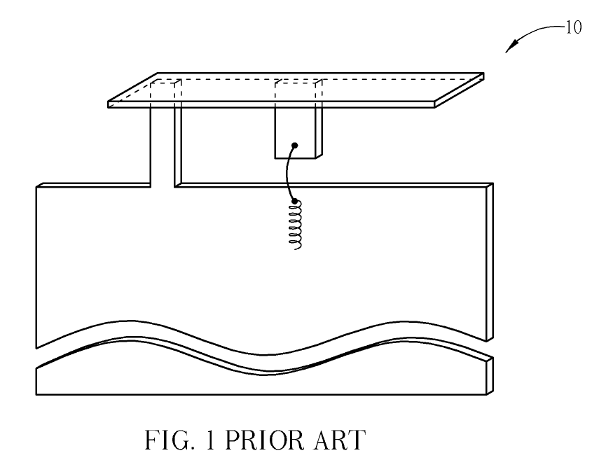

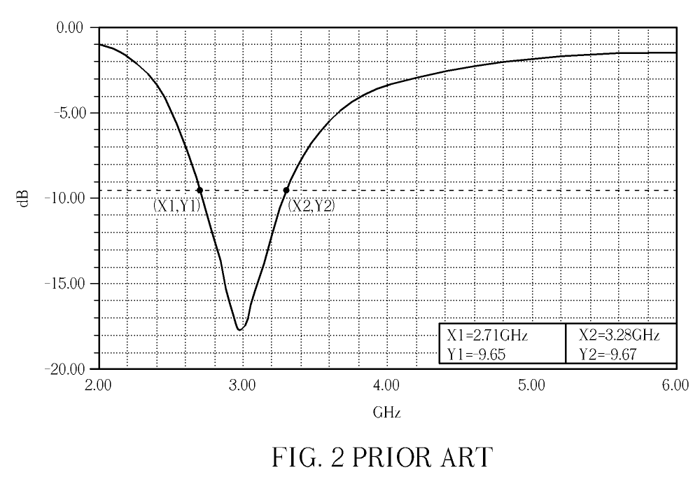

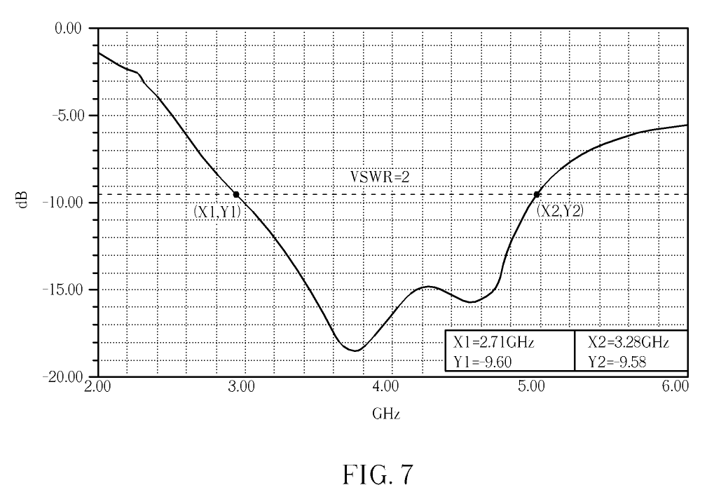

Therefore, with the two resonant modes, the wide-band antenna 30 achieves wide-band effect. Please refer to FIG. 7. FIG. 7 is a graph of return loss of the wide-band antenna 30. As shown in FIG. 7, in a condition of VSWR=2:1, a bandwidth of the wide-band antenna 30 is 4.97−2.95=2.02(GHz), a central frequency of the wide-band antenna 30 is (2.95+4.97)/2=3.96(GHz), and a bandwidth percentage is 2.03/3.96=51.01 (%). Obviously, the bandwidth and bandwidth percentage of the wide-band antenna 30 of the present invention are better than the prior art inverted-F antenna shown in FIG. 1.

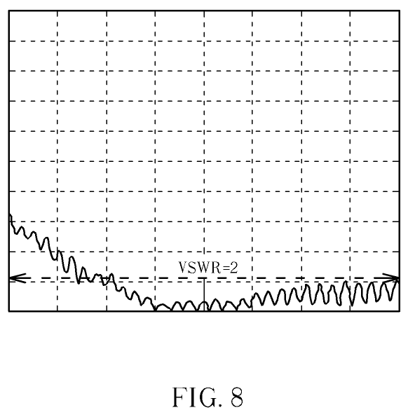

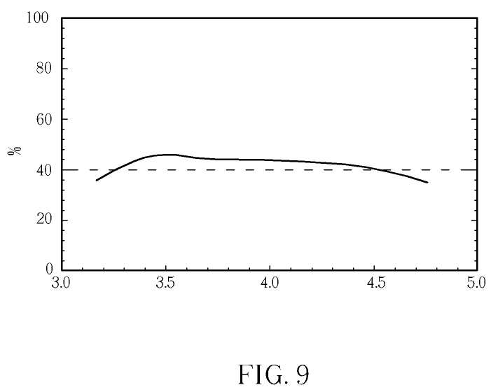

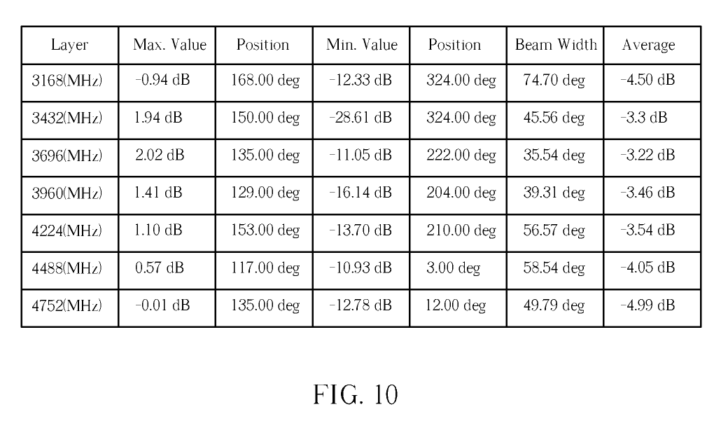

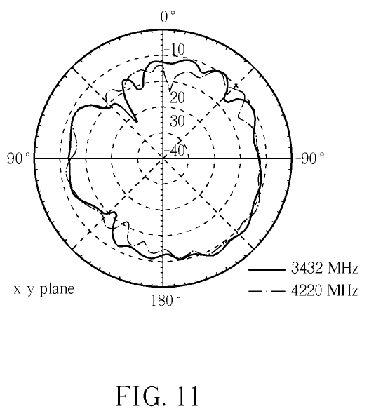

In addition, other radiation characteristics of the wide-band antenna 30 can be estimated by experiments. Please refer to FIG. 8 to FIG. 11. FIG. 8 is a graph of VSWR of the wide-band antenna 30. FIG. 9 is a graph of radiation efficiency of the wide-band antenna 30. FIG. 10 is a graph of average gain of the wide-band antenna 30. FIG. 11 is a graph of radiation pattern of the wide-band antenna 30. Note that, FIG. 7 to FIG. 11 are used for illustrating radiation characteristics of the wide-band antenna 30. Definitions and measurements of the radiation characteristics are well known for those skilled in the art and are not given here.

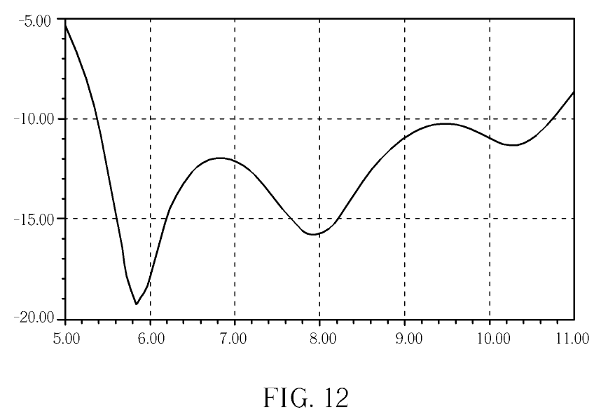

On the other hand, as those skilled in the art recognized, a signal transmission path of an antenna must be longer than or approximate to ¼ wavelength of a radio wave to be received or transmitted. For this reason, a designer can adjust the size of the wide-band antenna 30 according to required frequency and bandwidth. For example, targeting at a bandwidth range from 6 GHz to 10.6 GHz, the designer can adjust the size of the wide-band antenna 30 and get a graph of return loss as shown in FIG. 12.

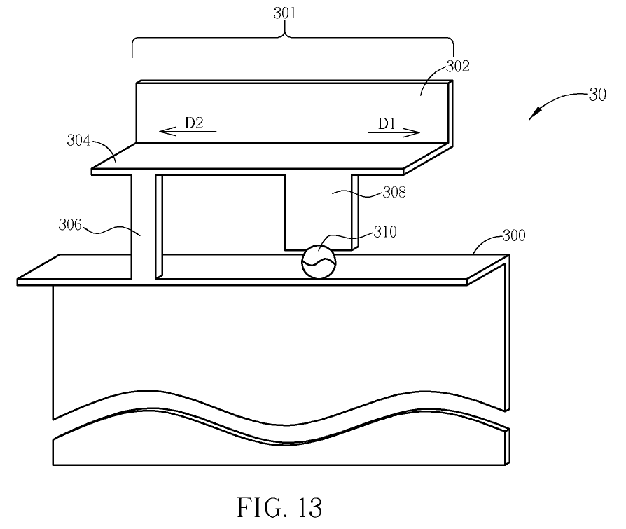

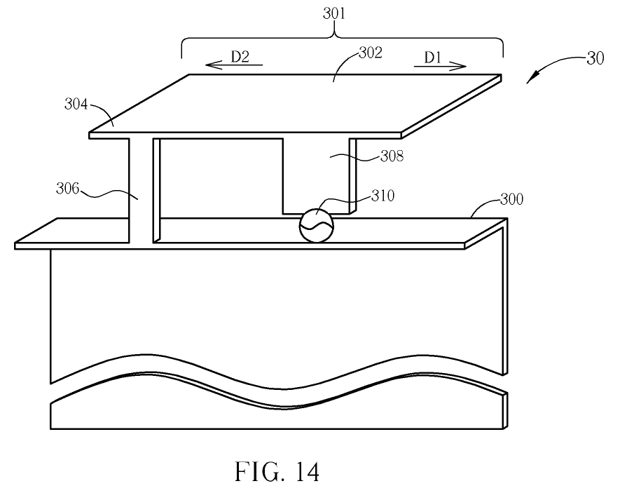

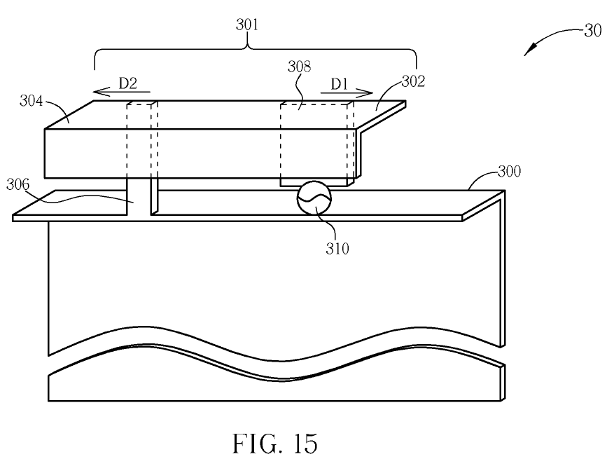

Note that, the wide-band antenna 30 shown in FIG. 3 is a preferred embodiment of the present invention, which uses the first radiator component 302 and the second radiator component 304 for generating two resonant modes, so as to increase bandwidth. Those skilled in the art can make alternations and modifications accordingly. For example, directions and numbers of bends in the first radiator component 302 or the second radiator component 304 can be adjusted according to the requirements. Please refer to FIG. 13 to FIG. 15. FIG. 13 to FIG. 15 are schematic diagrams of different kinds of bends of the first radiator component 302 and the second radiator component 304 in the wide-band antenna 30. The first radiator component 302 and the second radiator component 304 are bent upward as shown in FIG. 13, extended horizontally as shown in FIG. 14, and bent downward as shown in FIG. 15.

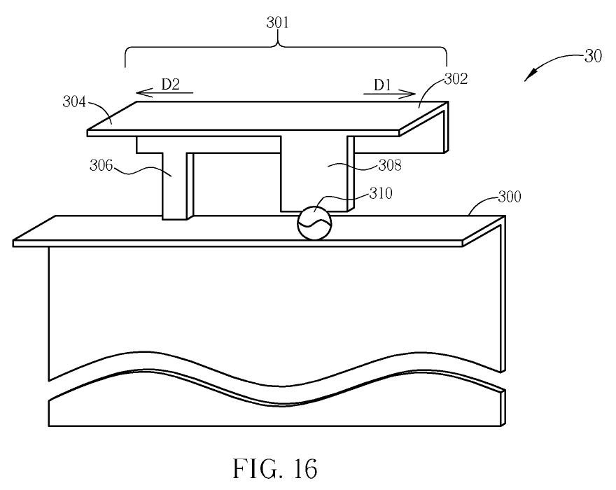

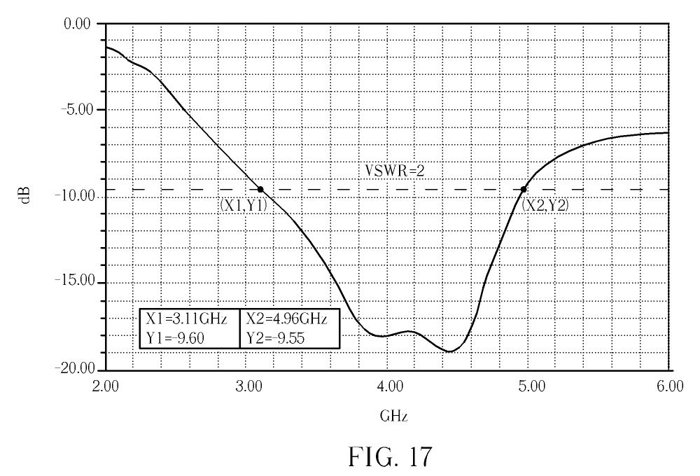

In addition, as shown in FIG. 3, the shorting unit 306 and the feeding unit 308 are installed on the same plane. Moreover, the shorting unit 306 and the feeding unit 308 can also be installed on different planes. Please refer to FIG. 16. FIG. 16 is a schematic diagram of a variation embodiment of the wide-band antenna 30. In FIG. 16, the shorting unit 306 is installed in back of the wide-band antenna 30, as in a different plane from the feeding unit 308. In such a case, the wide-band antenna 30 still achieves wide-band effect, and a corresponding graph of return loss is shown in FIG. 17.

From the above, the wide-band antenna 30 can effectively increase bandwidth and bandwidth percentage. Moreover, the wide-band antenna 30 has a simple structure with no bend in the shorting unit 306, and thus saves production cost.

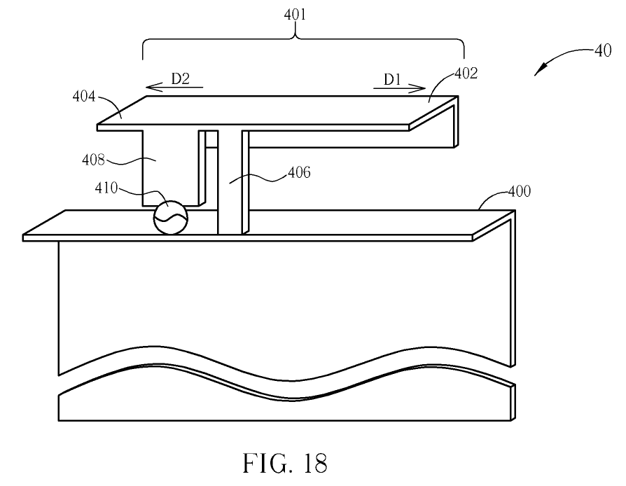

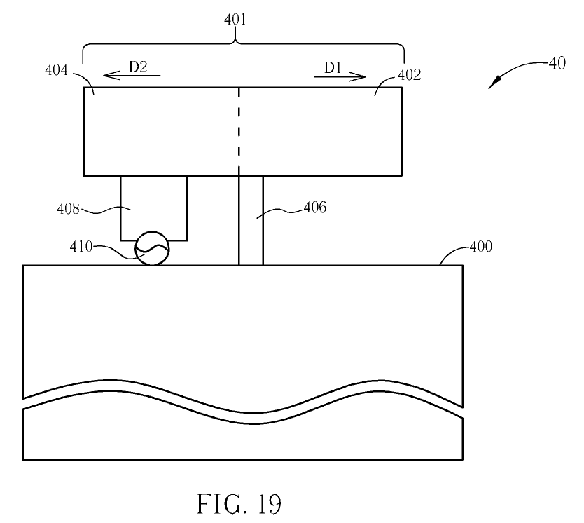

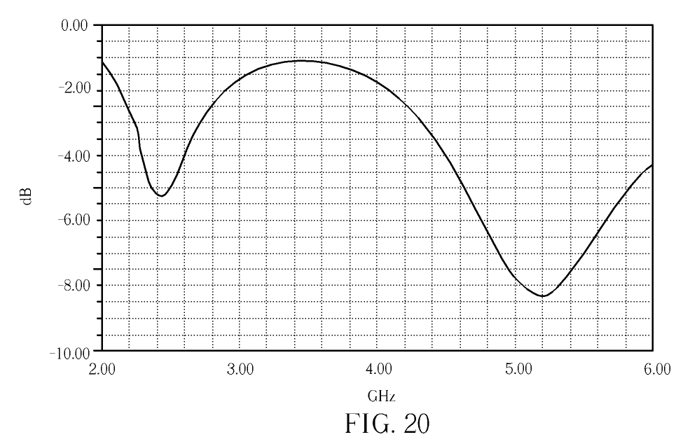

The wide-band antenna 30 shown in FIG. 3 is utilized for increasing bandwidth and bandwidth percentage. Moreover, the present invention further provides a dual-band antenna according to the wide-band antenna 30. Please refer to FIG. 18 and FIG. 19. FIG. 18 is a lateral-view diagram of a dual-band antenna 40 according to an embodiment of the present invention. FIG. 19 is a schematic diagram of an unfolded plane of the dual-band antenna 40. The dual-band antenna 40 comprises a grounding unit 400, a radiating unit 401, a shorting unit 406, a feeding unit 408 and a connector unit 410. The radiating unit 401 further comprises a first radiator component 402 and a second radiator component 404. The structure of the dual-band antenna 40 is similar to that of the wide-band antenna 30, and a difference is that the feeding unit 308 of the wide-band antenna 30 is connected between the first radiator component 302 and the connector unit 310 while the feeding unit 408 of the dual-band antenna 40 is connected between the second radiator component 404 and the connector unit 410. In such a case, a graph of return loss of the dual-band antenna 40 is shown in FIG. 20.

As shown in FIG. 20, the dual-band antenna 40 covers bands at 2.4 GHz and 5 GHz, which are used in the current WLAN. Comparing to the wideband metal-plate short-circuit monopole antenna disclosed in the TW published application No. 200618387, the dual-band antenna 40 has a simple structure, can save production cost, and occupies small space, is suitable for portable wireless communication devices.

As mentioned previously, the dual-band antenna 40 covers two different bands, has a simple structure, and saves production cost. Certainly, other embodiments can be derived from the dual-band antenna 40 as the variations of the wide-band antenna 30 shown in FIG. 13 to FIG. 16. In addition, the designer can adjust the size of the dual-band antenna 40 according to required frequency and bandwidth.

In conclusion, the present invention uses the first radiator component and the second radiator component for achieving wide-band effect or dual-band effect. Therefore, the present invention not only achieves wide-band effect or dual-band effect, but also has a simple and strong structure and effectively saves production cost.

Those skilled in the art will readily observe that numerous modifications and alterations of the device and method may be made while retaining the teachings of the invention.

What is claimed is:

1. A wide-band antenna comprising:
a grounding unit electrically connected to a ground;
a radiating unit comprising:
a first radiator component extending along a first direction of the radiating unit; and
a second radiator component electrically connected to the first radiator component and extending along an opposite direction of the first direction;
a shorting unit electrically connected between the radiating unit and the grounding unit;
a feeding unit electrically connected to the radiating unit; and
a connector unit electrically connected between the feeding unit and the grounding unit for receiving feeding signals.

2. The wide-band antenna of claim 1, wherein the first radiator component comprises at least one bend.

3. The wide-band antenna of claim 2, wherein the shorting unit and the feeding unit are installed on the same plane.

4. The wide-band antenna of claim 2, wherein the shorting unit and the feeding unit are installed on two planes parallel to each other.

5. The wide-band antenna of claim 1, wherein the second radiator component comprises at least one bend.

6. The wide-band antenna of claim 1, wherein the shorting unit is in the shape of rectangular, and one side of the shorting unit and a boundary between the first radiator component and the second radiator component form a straight line.

7. The wide-band antenna of claim 1, wherein a length of the first radiator component is longer than a length of the second radiator component.

8. A dual-band antenna comprising:
a grounding unit electrically connected to a ground;
a radiating unit comprising:
a first radiator component extending along a first direction of the radiating unit; and
a second radiator component electrically connected to the first radiator component and extending along an opposite direction of the first direction;
a shorting unit electrically connected between the first radiator component and the grounding unit;
a feeding unit electrically connected to the second radiator component; and
a connector unit electrically connected between the feeding unit and the grounding unit for receiving feeding signals.

9. The dual-band antenna of claim 8, wherein the first radiator component and the second radiator component respectively includes at least one bend.

10. The dual-band antenna of claim 9, wherein the shorting unit and the feeding unit are both installed on a plane.

11. The dual-band antenna of claim 9, wherein the shorting unit and the feeding unit are installed on two planes parallel to each other.

12. The dual-band antenna of claim 8, wherein the shorting unit is in the shape of rectangular, and one side of the shorting unit and a boundary between the first radiator component and the second radiator component form a straight line.

13. The dual-band antenna of claim 8, wherein a length of the first radiator component is longer than a length of the second radiator component.
